(19) United States
(12) Patent Application Publication
(10) Pub. No.: US 2012/0268292 A1
(43) Pub. Date: Oct. 25, 2012

(54) Remotely accessible environmental conditions station, systems and related methods

(76) Inventor: Dennis D. Rock, Anaheim, CA (US)

(21) Appl. No.: 13/451,306

(22) Filed: Apr. 19, 2012

Related U.S. Application Data
(60) Provisional application No. 61/478,201, filed on Apr. 22, 2011.

(51) Int. Cl. G08C 15/06

(52) U.S. Cl. 340/870.03

(57) ABSTRACT

The disclosure provides system for receiving real-time weather data with a personal weather station as well as non-weather visual or audio data, from a specific location, and for transmitting the data to a remote computer that requests the data.

### RELATED APPLICATIONS

This application claims benefit of priority of U.S. Ser. No. 61/478,201, filed Apr. 22, 2011, which is hereby incorporated herein in its entirety by reference.

### FIELD OF THE DISCLOSURE

This disclosure relates to devices and methods useful in gathering data for the weather conditions and terrain at remote locations.

### BACKGROUND OF THE DISCLOSURE

According to an aspect of this disclosure, a system is disclosed comprising an environmental conditions station having a plurality of environmental sensors, at least one audio or visual device, and a computer that is in data communication with the environmental conditions station and the internet. The computer receives real-time data from the plurality of environmental sensors and audio or visual devices and transmits the data via the internet to a remote computer requesting the data.

A method comprising with a plurality of environmental conditions sensors and at least one audio or visual device, collecting environmental conditions data, storing environmental conditions data gathered from the environmental conditions sensors on at least one computer, outputting via the environmental conditions data via the internet to a remote user together with one or more messages in a messaging space.

### SUMMARY OF THE DISCLOSURE

In embodiments, what is provided is a system comprising: an environmental conditions station having a plurality of environmental sensors; at least one audio or visual device; a computer that is in data communication with the environmental conditions station and the internet; wherein the computer receives real-time data from the plurality of environmental sensors, and real-time data from one or more audio or visual devices, and transmits the data via the internet to a remote computer requesting the data; wherein the data comprises weather data that is specific to a location, and wherein the data also comprises non-weather data that is specific to the same location. Also provided is the above system, wherein the environmental conditions station comprises a portable or personal weather station, wherein the portable or personal weather station provides weather information exclusively to said system. In another aspect, what is available is the above system, wherein the environmental conditions station consists of one or more portable or personal weather stations, wherein the at least one or more portable or personal weather stations provides weather information exclusively to said system.

What is also embraced, is the above system, that further provides calendaring information, wherein said calendaring information comprises information that is specific to the location. Furthermore, what is contemplated is the above system, that further provides calendaring information, wherein said calendaring information consists of information that is specific to the location. In yet another embodiment, what is provided is the above system, wherein the location is that of a social or a recreational event. Also available, is the above system, wherein the location is that of a social or recreational event comprising one or more of an exhibition, performance, competition, or naturally-occurring scenery. In other aspects, the present disclosure provides the above system, wherein the location is that of a social or recreational event, wherein said event is scheduled. In yet another embodiment, what is provided is the above system, wherein the location is that of a social or recreational event, wherein said event is not scheduled. Also contemplated, is the above system, that excludes weather data that is not specific to said location. Moreover, what is provided is the above system, that excludes real-time audio data that is not specific to said location, or excludes real-time visual data that is not specific to said location. What is also embraced, is the above system, wherein said non-weather data comprises one or more of information on density of mammals over a first area, density of vehicles over a second area, or density of buildings over a third area. Moreover, what is provided is the above system, wherein said non-weather data comprises one or more of information on density of mammals over a first area, density of vehicles over a second area, or density of buildings over a third area, wherein the first area, second area, and third area, overlap each other. In yet another embodiment, what is embraces is the above system, wherein said non-weather data comprises one or more of information on density of mammals over a first area, density of vehicles over a second area, or density of buildings over a third area, wherein the first area, second area, and third area, wherein the first, second, and third area, are identical to each other in terms of location and size. Additionally, what is provided is the above system, wherein the plurality of environmental sensors are capable of detecting one or more of outside temperature, temperature inside a building, wind speed, wind direction, humidity, atmospheric pressure, precipitation, intensity or wavelength of light, or any combination of the above.

Moreover, what is contemplated by the present disclosure is the above system, that excludes information that is weather forecast information. Also supplied, is the above system, that excludes information obtained from a weather widget. Furthermore, what is embraced is the above system, further comprising a web site, wherein said real-time data is exclusively available from said web site. In yet another aspect, what is provided is the above system, further comprising a web site, wherein said real-time data is exclusively available from said web site, the system further providing calendaring information that comprises information specific to the location, wherein said calendaring information is available from said web site.

In another aspect, what is provided is the above system, wherein the transmittal of data via the internet to a remote computer that requests the data, requires transmittal of a password from a user from the remote computer to the system. Also embraced, is the above system, comprising a plurality of environmental conditions stations, each station in combination with at least one audio or visual device, at least one computer that is in data communication with the plurality of environmental conditions stations and audio or visual device, the at least one computer also in data communication with the internet, wherein each of the plurality of environmental conditions stations is in a distinct location and provides weather data that is specific to the distinct location, and wherein each of the at least one audio or visual devices provides data that is specific to the distinct location. The plurality can be two, three, four, five, or more, at least 10, at least 50, at least 1,000, and the like. Also embraced, is the above system, wherein the location is that of a social event or recreational event, wherein the event is ongoing, wherein the event does not have a distinct start date, or wherein the event is not scheduled. In another aspect, what is contemplated is the above system, wherein the data from the at least one audio device comprises ambient sounds. Moreover, what is disclosed is the above system, wherein said non-weather data comprises information on a plurality of areas within said location, wherein none of the areas are identical to each other in terms of size, locale, or viewing angle from said visual device. Furthermore, what is contemplated is the above system, wherein said non-weather data comprises information on a plurality of areas within said location, wherein each of the areas is distinct from each other.

What is provided is the above system that involves transmittal of data via the internet to a remote computer that requests the data, wherein what is not required by the system, or wherein what is excluded from the system, is transmittal of a password from a user from the remote computer to the system.

In one or more methods embodiments, what is disclosed is a method for providing real-time data acquired from the plurality of environmental sensors and from at least one audio or visual device, comprising installing a portable or personal weather station at a first location, wherein said portable or personal weather station is wireless (and/or does not communicate with a wire or cable), and installing at least one audio or visual device at the same first location, wherein said at least one audio or visual device is wireless and does not communicate with a wire or cable, wherein said method provides real-time data using the above system.

### BRIEF DESCRIPTIONS OF THE FIGURES

FIG. 1 is a block diagram of an embodiment of a system for gathering and providing to remote users real-time environmental data; and

FIG. 2 is an exemplary embodiment of a webpage available to remote users to give the remote user site specific, real-time environmental data.

### DETAILED DESCRIPTION

In the following detailed description of embodiments of the present disclosure, reference is made to the accompanying drawings in which like references indicate similar elements, and in which is shown by way of illustration specific embodiments in which the present disclosure may be practiced. These embodiments are described in sufficient detail to enable those skilled in the art to practice the present disclosure, and it is to be understood that other embodiments may be utilized and that logical, mechanical, electrical, functional, and other changes may be made without departing from the scope of the present disclosure. The following detailed description is, therefore, not to be taken in a limiting sense, and the scope of the present disclosure is defined only by the appended claims. As used in the present disclosure, the term “or” shall be understood to be defined as a logical disjunction and shall not indicate an exclusive disjunction unless expressly indicated as such or notated as “xor.”

As used herein, the term “environmental” shall mean the space around an environmental conditions station, and shall include bodies of land, bodies of water, and air surrounding the environmental conditions station.

As used herein, the term “real-time” shall mean the instantaneous moment of an environmental event or condition, or the instantaneous moment of an event or condition plus a period of elapsed time wherein the environmental event or condition is still meaningful after the short period of time, wherein the state of an event or condition being measured is substantially the same as that of the instantaneous moment irrespective of any elapsed time interval. For example, a temperature measurement at an environmental conditions station is taken every ten minutes; a viewer looking at the temperature report, even nine or ten minutes elapsed, will still find the temperature data useful and approximately representative of current environmental conditions because the temperature is unlikely to be more than a degree or two different. Such reporting of temperature would be considered “real-time” as used in this disclosure. Thus, the term “real-time” shall encompass reasonable periods of time after a measurement is made in which the data is still approximately the same as real-time measurements. Used in this context “substantially the same” shall mean that the data for the event or condition remains useful for the purpose for which it was gathered, even after the elapsed time period.

The devices and methods of this disclosure address a long standing problem of making site specific weather and terrain conditions available to remote users. Although a remote user can use local news information or online weather sites to get weather forecasts, such forecasts are unable to provide real-time data to let the remote user know the conditions at the site in real-time. Moreover, such forecasts tend to be generalized to large areas, but fail to address specific areas, such as a particular beach or a trailhead, for example. Moreover, depending on the specific site, specialized real-time data is useful. For example, at a trailhead, it is useful to know temperature and recent rain or snow totals prior to driving out to the site. Conversely, at a nuclear power plant, the ambient radiation outside the plant and inside the plant may be monitored. Because environmental conditions often happen at a micro level, such specific, detailed reports are immensely useful.

The environmental conditions systems described herein comprise various environmental conditions sensors installed at a particular geographic location (site), which are in data communication with a computer. The environmental conditions sensors are used for the collection of environmental conditions data. The data is then distributed over a local or wide area network to the internet. The onsite real-time or delayed environmental conditions data, such as weather, security, safety, general or other site data is transmitted to and received by a remote user via a website or via other non-proprietary or proprietary software. The remote user can use computers, such as laptops, desktops, mobile handheld internet enabled computing devices, or cell phones at the request of the remote user using the designated website or other software.

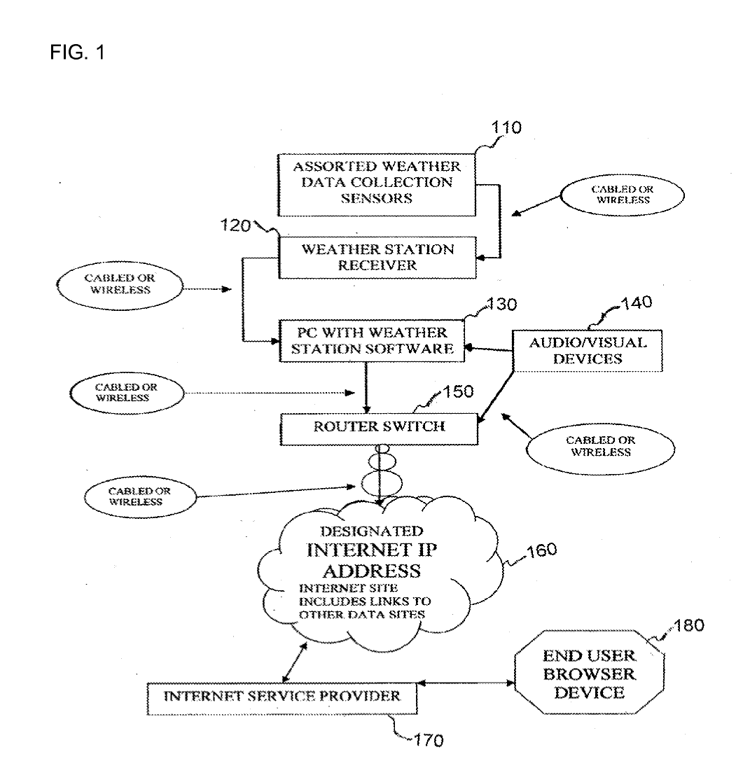

FIG. 1 discloses internet transmission of site data to a designated web site. According to embodiments and as illustrated in FIG. 1, there is shown a block diagram of an environmental conditions system for providing to remote users real-time environmental conditions data. As illustrated in FIG. 1, environmental conditions sensors 110 collect environmental conditions data in real-time. According to embodiments, wind direction, wind speed, temperature, humidity, atmospheric pressure, and precipitation data are collected. Other data that may be useful includes pollen count, particulate or other pollution, ultraviolet and other types of radiation, water or ground temperature, etc. Other environmental conditions data can also be collected depending on the type of environmental conditions station desired. Additionally, such data may be used in conjunction with other types of useful data such as security and safety conditions data, or other messages from the operator or owner of a site where environmental conditions are monitored, or by other interested third parties.

For example, an environmental conditions station at the beach might be specialized to collect wind direction and speed, humidity, temperature, wind chill or heat index, atmospheric pressure, precipitation measurements, water temperature, or water salinity. According to another example, an environmental conditions station outside a nuclear power plant may measure outside temperature, inside temperature at one or more locations, wind direction and wind speed, radiation measurements both outside and inside the plant, and precipitation to allow remote users to evaluate environmental conditions at the plant in the event of an emergency or on an every-day basis. According to another example where the environmental conditions station monitors environmental conditions at a school, the data collected may comprise wind speed, temperature, wind chill or heat index, atmospheric pressure, and precipitation to allow parents to determine how to dress children. According to yet another example, an industrial work yard in a bad part of town may monitor one or more weather conditions as well as security of the work yard, thereby allowing workers to know current conditions, but also monitor the security of the work yard. According to embodiments, the environmental conditions station will include collection of data that will provide remote users with useful real-time information for the specific site in which the environmental measurement station is located.

According to embodiments, environmental conditions sensors 110 comprise barometers, thermometers, rain gauges, wind vanes, anemometers, hygrometers, psychrometers, dewcells, solarimeter, and other instruments useful in collecting environmental data. According to embodiments, the environmental conditions may receive current date and time information via radio wave over amplitude modulation, satellite, or other commonly practiced methods for receiving accurate time or data. According to embodiments, each instrument for collecting environmental conditions is able to provide a signal whereby receiver 120 at the environmental conditions station electronically compiles the environmental conditions data and stores it in a machine-readable form. Environmental conditions sensors are digital or analog, active or passive, according to embodiments.

According to embodiments, the environmental conditions station comprises audio or visual devices 140, which provide one or more real-time video, images, or audio feeds for the site. Use of audio or visual feeds allows remote users to further qualitatively evaluate environmental conditions at a site visually or audibly. For example, a mountain biker riding to a mountain peak may wish to determine whether snow is on the ground or whether the trail is muddy, or the rider may wish to know the temperature at the peak prior to starting the ride.

Turning again to FIG. 1, environmental conditions sensors 110 collect data that is conveyed to receiver 120 via wire or wirelessly. According to embodiments, receiver 120 comprises a computer or specialized software implemented on a computer or other machine configured to receive environmental conditions data from the various instruments. According to other embodiments, receiver is a stand-alone machine that can be connected to a computer via wire or through common wireless communication protocols (e.g., IEEE Standards 802.11b, 802.11g, 802.11n, 802.15, 802.16, or cellular communications protocols such as EDGE, UMTS, CDMA, or others) or via proprietary wireless communication protocols.

Ultimately, the environmental data is stored on computer 130, such as a web server (Apache, Microsoft IIS, or other common or proprietary servers), which is likewise connected to network device 150 that is in data communication with the internet 160. Remote users access computer 130 storing the environmental data via browser 180 via internet service provider 170. Computer 130 may serve a single environmental conditions station or multiple environmental conditions stations, depending on its location. According to embodiments, computer 130 is located at a remote location from environmental conditions station, whereby environmental data is communicated to computer 130 via the internet or other common or proprietary wired or wireless networking protocols. Environmental data may be saved in a database, for example, for later use in comparing data current data with the saved data, that is, for comparing data from two different days, or for comparing data from two different occurrences of an annual event.

According to embodiments, environmental conditions data from one or more environmental conditions systems are stored in a database (e.g., MySQL, Oracle, etc.). The database can be maintained on a single computer or group of computers that do not serve the data as part of a webserver, but exist as a repository of the environmental conditions data in which a local or remote server or software may retrieve the data.

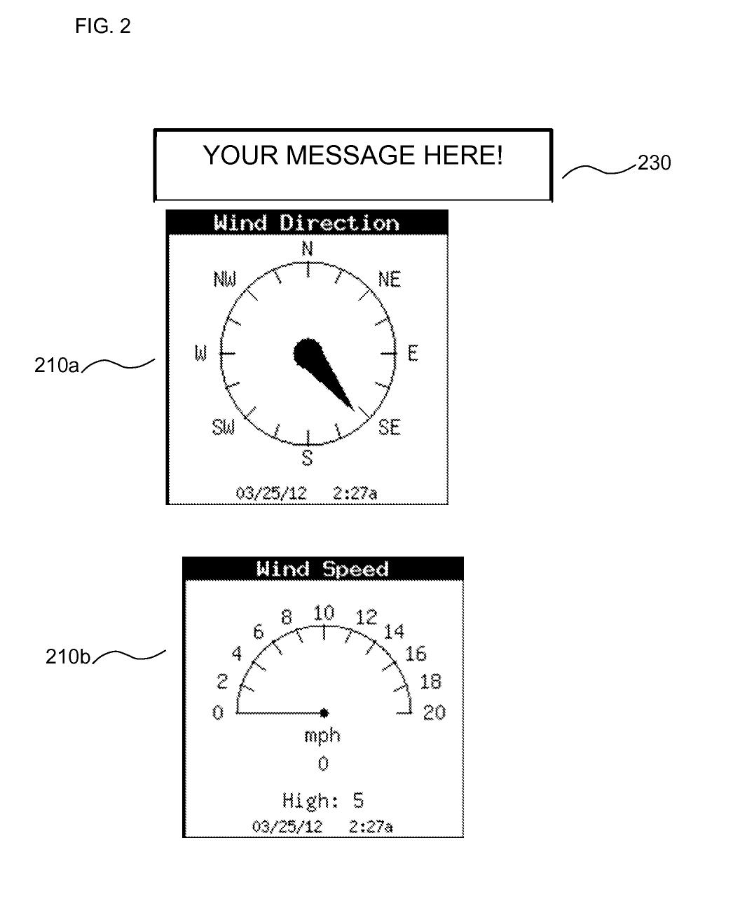

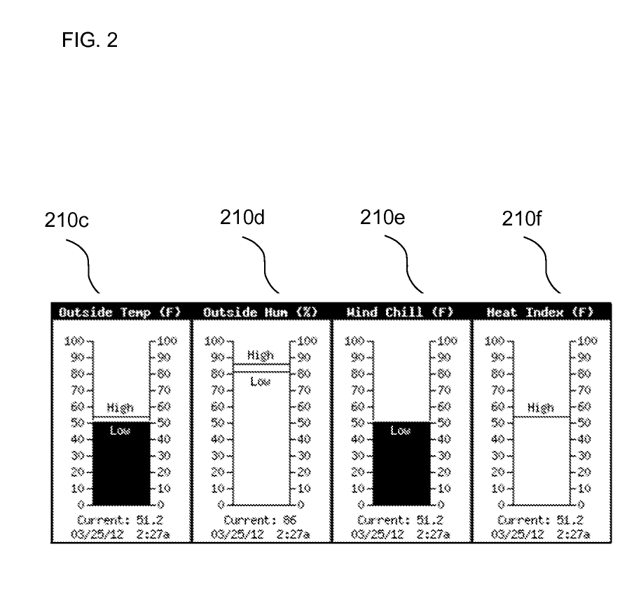

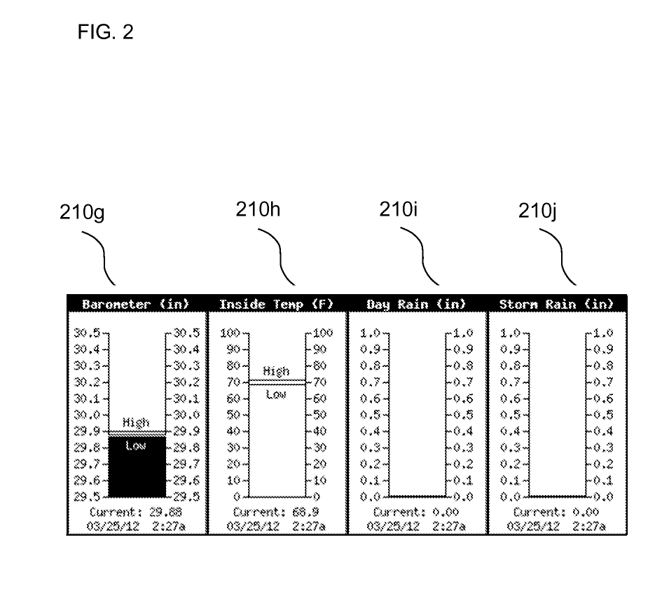

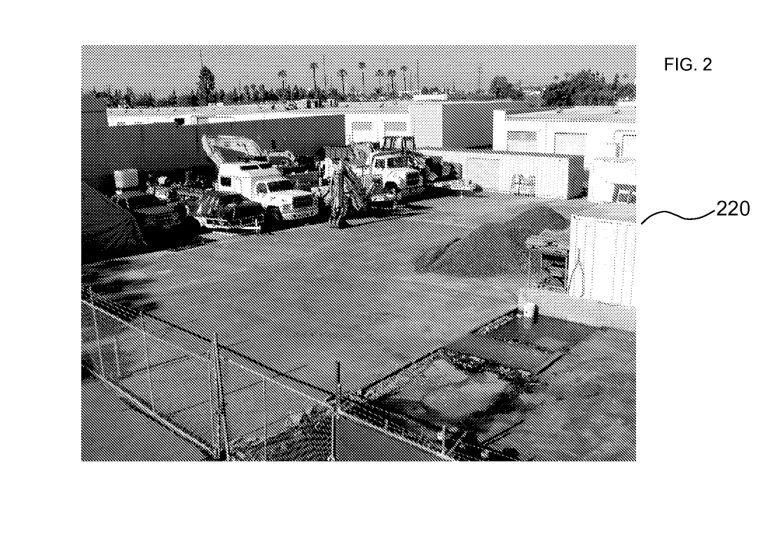

FIG. 2 illustrates an embodiment of webpage 200 that a remote viewer might see when viewing environmental conditions data at a remote site. As shown, webpage 200 contains a plurality of data fields 210a-210j, and audio or visual display 220, and messaging areas 230. To provide a non-limiting example, there can be one messaging area only, two messaging areas, or three or more messaging areas, and the like. Messaging areas can be relatively large or small, with respect to each other. An example of a small messaging area (230) is, “For additional area forecasts, visit HERE (Zip code: 92867).” According to embodiments, exemplary webpage 200 contains the following data fields: wind direction field 210a, wind speed field 210b, outside temperature field 210c, outside humidity field 210d, wind chill field 210e, heat index field 210f, atmospheric pressure field 210g, inside temperature field 210h, daily rain field 210i, and storm rain field 210j (which measures total rain fall for a given storm system). According to embodiments and for a given environmental conditions station, not all data collected at the environmental conditions station is shown on webpage 200. Similarly and according to embodiments, additional environmental conditions data, which is extrapolated from the environmental data collected from the environmental conditions station are shown on webpage 200. For example, in FIG. 2, both wind chill 210e and heat index 210f shown, but are not directly collected by environmental conditions sensors 100; rather they are extrapolated or calculated from other data collected.

Audio or visual display 220 shows feeds of one or more audio or visual feeds. As shown in FIG. 2, a single video feed is shown. According to embodiments, each video feed is configured to alternate between one or more audio or visual sources. According to other embodiments, a plurality of audio or visual displays 220 are shown on webpage 200. Each audio or visual display 220 may show one or more audio or visual feeds, according to embodiments.

Messaging area 230 allows for messages to be input by advertisers or administrators. For example, if webpage 200 is showing data for a school, messaging area may be used to show advertisements to raise revenue for the school or make official school announcements, such as snow days. Variations on this display and the data fields 210 shown in the display are expressly contemplated, and will comprise data fields 210, audio or visual data 220, or other messages 230 as needed on a case by case basis.

According to embodiments, environmental conditions sensors 110 or audio or visual devices 140c that are able to record or transmit an audio or visual feed are installed and maintained by the administrator of the environmental conditions system to the owner or operator of the particular geographic site to be monitored. Messaging areas may be used, in part, to show advertisements that subsidize the cost of the environmental conditions station equipment and operation. Site equipment resident time will be determined by the site owner or operator and environmental conditions system administrator or an active sponsoring party or multiple sponsoring parties. Thus, according to embodiments, the environmental monitoring site can be installed in a variety of locations, such as beaches, trails, parks, or other common areas where the likelihood of using the environmental monitoring station would be unlikely to be profitable on its own merits.

In various embodiments, the systems, devices, and methods disclosed herein is operational in an information technology infrastructure or with numerous other general purpose or special purpose computing system environments or configurations. Examples of well-known computing systems, environments, or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The methods or processes disclosed herein may be described in the general context of computer-executable instructions, such as program modules, being executed by a computer. Generally, program modules include routines, programs, objects, components, data structures, etc. that perform particular tasks or implement particular abstract data types. The system may also be practiced in distributed computing environments where tasks are performed by remote processing devices that are linked through a communications network. In a distributed computing environment, program modules may be located in both local and remote computer storage media including memory storage devices. The computer programs are stored in a memory medium or storage medium or they may be provided to a processing unit through a network or I/O bus.

According to embodiments, the machines in the environmental conditions system include at least one central processing unit (CPU) or processor in one or more of the machines. The CPU can be coupled to a memory, ROM, or machine readable media containing the computer-executable instructions for generating and using fingerprints for integrity management. Machine readable media can be any available media that can be accessed by the system and includes both volatile and nonvolatile media, removable and non-removable media implemented in any method or technology for storage of information such as machine readable instructions, data structures, program modules or other data. Computer storage media includes, but is not limited to, RAM, ROM, EEPROM, flash memory, portable memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the environmental conditions system. The machine readable media may store instructions or data which implement all or part of the system described herein.

According to embodiments, communication media typically embodies machine readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of any of the above can be used in conjunction with machine readable media.

While the apparatus and methods have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

Without implying any limitation, the system and method of the present disclosure may be called, “Wuzhapnen®.” Wuzhapnen utilizes a personal weather station (or portable weather station), a camera, and a calendaring device. The weather station includes, for example, one or more of sensors for wind direction, wind speed, temperature, humidity, precipitation, snow, airborne pollution, airborne pollen, and so on.

In other embodiments, all devices of the present system and method, except for power source, are wireless, or are cabled, or are wireless and cabled. Preferred sources of power are from an electric transmission line that transmits power from a remote source such as a hydroelectric dam or coal-burning generator. Alternatively, embodiments encompass sources of power that are local, e.g., battery, fuel cell, solar cell, gasoline generator, and the like. In embodiments, all sensors are provided in an integrated unit, that is, in a single portable weather station. In other embodiments, one or more sensors are stand-alone sensors, and are not part of an integrated portable weather station.

In a non-limiting embodiment, portable or personal weather station is reversibly attached to a permanent structure, such as a tower or building. In another non-limiting embodiment, portable or personal weather station is securely or irreversibly attached to a permanent structure, such as a tower or building, for example, in the situation where an event is of a continuing day-to-day nature, or of a recurring and periodic nature. In other embodiments, portable or personal weather station is not attached to a permanent structure, that is, it may reside on the ground, reside on a hovering balloon, or be supported by a tripod. The embodiments may also be applied to any audio or visual equipment.

System and method of the present disclosure comprises (1) Real-time weather information (other than a camera image of weather) of a location of interest; and (2) A camera image of the location of interest. In another aspect, system and method comprises (1) Real-time weather information (other than a camera image of weather) of a location of interest; (2) A camera image of the location of interest, and also (3) Calendaring information.

In some embodiments of Wuzhapnen®, what is excluded are systems that do not include a camera that monitors real-time weather conditions. In embodiments, system and method includes still camera images, but excludes video camera (motion picture) images. In other embodiments, system and method provides audio information at the location of interest. In embodiments, system and method excludes embodiments that provide only weather information. In other words, what is excluded in certain embodiments, are systems or methods that fail to provide all three of: (1) Real-time weather information (other than a camera image of weather) of a location of interest; (2) A camera image of the location of interest, and (3) Calendaring information.

### Sources of Weather Information

In embodiments, system and method excludes information that takes the form of a weather forecast. In another aspect, system and method includes information that is not a weather forecast, but that instead comprises a weather trend, for example, a trend that is an average of weather from the past decade for a particular month, or particular week in a particular month. Alternatively, system and method excludes information that comprises weather forecast information. In other embodiments, system and method includes information that is weather forecast information. In non-limiting embodiments, what is excluded is weather information from, for example, airport meteorologists, National Oceanic and Atmospheric Administration (NOAA), or weather widgets, such as Weatherbug®, Weather Underground®, and the like.

Weather widgets include, e.g., Weatherbug®, Weather Center®, MSN Weather®, and Weather Channel®. Weather widgets are described (see, e.g., N.C. Zakas et al (2007) Professional Ajax, 2^{nd} ed., Wiley Publ., Indianapolis, Ind.; P. Chaganti (2007) Google Web Toolkit, Packt Publ., Birmingham, United Kingdom; 2010/0305999 of Fujioka, 2010/0257196 of Waters et al, and 2010/0333145 of Chen et al, each of which is incorporated herein in its entirety).

Without implying any limitation, disclosure excludes weather widgets, excludes weather information obtained from one or more weather widgets, encompasses one or more weather widgets, or encompasses weather data obtained from one or more weather widgets.

In embodiments, weather sensor, camera, or other audio-visual devices (140) as well as information from weather station (120), gets sent to the router (150) which, in turn, transmits both types of information to the Wuzhapnen® web site on the internet (160). In embodiments, system includes a Domain Name Server (DNS) that is a possession of Wuzhapnen, or alternatively, includes a DNS that is outsourced to a domain registration provider.

### Instruments and Hardware

Portable (or personal) weather stations are available. See, e.g., Vantage Vue® Weather Station (Davis Instruments, Hayward, Calif.); Wireless Weather Envoy® (Davis Instruments); Ambient Weather WS-1171 Wireless Advanced Weather Station (Ambient Weather, Chandler, Ariz.); Meade TE653ELW-M Weather Station (Meade Instruments, Irvine, Calif.), Honeywell TE242ELW Personal Weather Station (Honeywell, Morristown, N.J.). Detectors or sensors for measuring pollen, smog, and the like are available (see, e.g., U.S. Pat. No. 7,119,900 issued to Okumura et al, U.S. Pat. No. 7,610,794 issued to Yamaguchi et al, 20090318068 of lida et al, which are incorporated herein by reference). Barometers, air quality devices, moisture detectors, wireless weather stations, wind meters, and the like, are available from W.W. Grainger, Lake Forest, Ill., and from Davis Instruments, Hayward, Calif.).

Moisture sensors that measure moisture in the ground or earth, rain sensors, and wind sensors are available (see, e.g., U.S. Pat. No. 6,234,403 issued to Grott, which is incorporated by reference, Gardena, Huskvarna, Sweden; Rain Bird,. Azusa, Calif.; Hunter Rain-Clik and Hunter Wind-Clik, Hunter Industries, San Marcos, Calif.). Still cameras and video cameras, including wireless still cameras and video cameras, are available. See, e.g., Panasonic BB-HCM371A Outdoor Wireless Network Camcera with 2-W Audio; Panasonic BL-C230A Wireless Internet Security Camera, Panasonic, Secaucus, N.J.; Agasio M105I Outdoor Wireless Wifi IP Camera, Agasio Technologies; Wansview Wireless IP Pan/Tilt/Night Vision Internet Surveillance Camera Built-in Microphone, Wansview Guangzhou, Guangdong; Linksys WVC80N Internet Home Monitoring Camera, Hewlett-Packard, Palo Alto, Calif.; Foscam FI8918W Wireless/Wired Pan & Tilt IP/Network Camera, Foscam Electronics, Shenzhen). In some embodiments, all devices of the present system and method are wireless. In one aspect, portable weather station and/or camera is firmly mounted in a stationary position, for example, on the side of a building or on a telephone pole. In non-limiting embodiments, portable weather station and/or camera can be located on a buoy, island, peninsula, or airborne balloon.

Regarding camera, videocamera, and the like, camera can provide still images only, motion images only, or both still and motion images. The direction of the lens can be aimed at the sky, at the ground, or in a horizontal direction, and the angle of the lens can be, for example, a wide angle lens of about 21 mm, standard lens of 50 mm, and telephoto lens of 200 mm, or a zoom lens that can be controlled to provide varying fields of vision. In other embodiments, the direction and/or field of vision can only be controlled by management of Wuzhapnen, by event manager, by user (e.g., when viewing the system's web site from a home computer), or by any combination of the above. The camera can supplement the weather information provided by the portable weather station, for example, by confirming the weather station's information regarding cloudiness, sunshine level, precipitation, or snow. For example, the camera can inform the user of Wuzhapnen about the presence of ice, size of hailstones, or whether a particular hiking area is muddy, if the destination of a hiking trail is in optimal condition, e.g., whether a waterfall is flowing or dry, or whether wildflowers are in bloom or not. In addition, the camera can provide information that is not directly related to the weather, such as the size of a crowd at a sporting event, whether a parking lot for a calendared event is partly full or totally full, or whether a bridge or highway leading to a calendared event is clogged with slow-moving vehicles.

### Calendaring and Advertising

System and method of the present disclosure provides calendaring information to users. Calendaring information can be provided on the home page of Wuzhapnen®, by way of other pages of the Wuzhapnen web site that can be opened by clicking on the home page, by way of links on the Wuzhapnen web site, by way of pop-ups on the home page, and the like. The name, Wuzhapnen, is non-limiting and is used herein only as an example.

In embodiments, system and method of Wuzhapnen, encompasses an internet web site that can display text or images that disclose one or more calendared events, that disclose advertising, or that disclose both one or more calendared events and advertising. For the example, where the calendared event is a golf tournament, the image from the web site can be that of the golf course or of a golfer, and the advertisement can be an image of golf clubs manufactured or distributed by the advertiser, or the name of a golf equipment manufacturer, e.g., Titleist®.

In embodiments, system and methods, for example, of Wuzhapnen®, includes calendaring information, that is, information relating to social activities such as automobile exhibitions, automobile racing, county fairs, horseracing, animal exhibitions (e.g., dog shows), auctions, athletic events, church activities, garage sales, commercial or municipal golf courses, arts and crafts exhibitions, parades, exhibitions or recitals of dance or music, and the like. In certain embodiments, system and method excludes systems that do not encompass calendaring, excludes systems that do not allow users to input calendaring information, excludes systems that do not allow users to acquire (read; view) calendaring information, and any combination of the above.

In embodiments, the general public can post information on the calendaring device of the web site, without prior permission from Wuzhapnen, or without prior registration with Wuzhapnen. In other aspects, the general public must first acquire permission, or must first register, before posting information on the calendaring device. Alternatively, the general public must transmit calendaring information to Wuzhapnen management, where management posts the information. In another embodiment, the Wuzhapnen web site automatically acquires calendaring information from other web sites, from radio or television broadcasts, from cable television broadcasts, and such, and then posts this information on Wuzhapnen's web site.

In some embodiments, system is configured to provide an offer to a user, when user gains access to or views the Wuzhapnen web site. The offer can encompass one or more of information (e.g., information on performers or artisans at event), a discount, rebate, coupon, membership, or a tangible gift (e.g., food or weather gear), and the like. System, and related method, is also configured to receive user's acceptance of the offer. In embodiments, discount, rebate, coupon, membership, is related to one or more events, related to calendered information on the Wuzhappen web site, or related to the weather (e.g., raincoats, down vests, weather gear, suntan lotion, and the like).

### Location-Specific Web Sites

Multiple versions of the present embodiment are available, that is, Wuzhapnen® web sites that are specific to northern California, to southern California, to the Wisconsin and Minnesota area, to the Carolinas, or to specific districts, boroughs, or parishes in one city, where the web site encompasses at least one, or encompasses a plurality of personal weather stations, each weather station covering a location that is distinct and separate all of the other weather stations of the present system. Real-time information on weather, video, and/or audio, for events taking place in southern California, for example, as well as related calendaring information, can be limited to one particular species of Wuzhapnen web site. In embodiments, Wuzhapnen is capable of detecting the location of the user when the user opens the Wuzhapnen web site, and then the system directs user to the appropriate location-specific web site. In other embodiments, user clicks on a location of interest from a list of choices, or alternatively, types in the name of a location or a zip code corresponding to the location of interest. In a non-limiting embodiment, system limits calendaring to one or more specific web sites (what can be limited or screened or is initial input of the calendaring information to the web site, or export of calendaring information from web site to users).

Coordinating System Power-Up with an Event

In embodiments, system is installed in synchrony with preparation for an event, or in synchrony with start date of an event, and dismantled in synchrony with termination of the event. In embodiments, the disclosure provides a system that is electronically activated, for example, by switching on camera of the system or sound detector (audio) of the system, in synchrony with start date of the event. The system can be electronically activated (and deactivated) by owner or administrator of the system, or in addition or alternatively, the system can be electronically activated (and deactivated) by a person who is not an administrator of the system, for example, a person associated with the event, such as a scheduling manager.

### EXAMPLES

Wuzhapnen® integrates the utilization of camera images, weather information, and calendaring, as illustrated by the following non-limiting example. Residents living in the San Francisco Bay area, in California, are interested in music festivals held at the Russian River, located about two hours by automobile to the north of Oakland. However, slow traffic across the San Francisco Bay Bridge, across Golden Gate Bridge, and along Highway 101, have the potential to double this traveling time. Moreover, periodic stormy conditions, flooding, landslides, and thick fog, along the Russian River have the potential to cause disappointment to travelers, and to induce regret for embarking on the trip to the area of the Russian River. The Russian River Music Festival can be a client of Wuzhapnen®. As a client, the festival management can request that cameras be trained on relevant bridges or highways where traffic is a frequent problem, that a portable weather station be set up on the grounds of the festival, and that one or more cameras be set up in the grounds of the festival. Cameras in this, and in other embodiments, can be used to monitor weather, to detect available parking, to detect traffic problems, and to detect security issues.

Wuzhapnen can derive revenue paid directly by festival management, or paid directly by representatives of the performers. Alternatively, or in addition, Wuzhapnen can acquire revenue by accepting paid advertising, for example, advertising for the music festival, or advertising paid by nearby motels, restaurants, or advertising paid by real estate agents representing property in the general area, and the like. In another embodiment, users can submit payment on a per use basis, or as paying members or subscribers of Wuzhapnen.

The calendaring feature of the present disclosure, in this non-limiting example of the festival, can include events or tourist attractions in nearby locations such as vineyards in nearby Napa Valley, hiking trails and Shakespeare play performances in nearby Armstrong Woods State Park, or arts and crafts fairs in the nearby City of Sonoma. The calendaring time frame provided by system and method can be, for example, events or attractions available only on the day of the user's inquiry, only on the day of the inquiry and in the next two weeks, only on the day of the inquiry and in the previous two weeks and next two weeks, only on the day of the inquiry and in the previous two months and next two months, or the sum of all calendaring information from the present day, the previous 20 years, and next 20 years, and so on. Information on past events and attractions are useful for prompting the user to attend the same event, if it is an annual event, when it occurs a year later. Thus, users interested in attending Russian River Music Festival, can view the web site of Wuzhapnen, and obtain real-time weather information, that is, text and/or images, provided by one or more personal weather stations located at the site of the music festival, real-time still images or real-time video images of potential bottlenecks during travel, e.g., across bridges and along highways, real-time images of nearby local attractions, e.g., hiking trails. The information presented above is not limited to music festivals, but can also be applied to other locations where weather is a factor, for example, locations used for routine business (e.g., the delivery of mail); sports events; company picnics; events that are natural phenomena (e.g., animal migrations, meteor showers, or waterfalls). In each case, user connects to the Wuzhapnen web site, and receives information on the weather at the specific location of the event. As indicated above, the weather itself can be the event of interest. In embodiments, present disclosure does not compare activities or events with weather, or does not rank activities or events according to the weather in the location of that activity or event.

In embodiments, the system is configured so that an event manager can activate (turn on power) personal weather station, activate audio or camera, or both, at about the time the event starts, or can turn off power (deactivate) at about the time the event concludes. The event manager's action in turning on or off power avoids or reduces the need of manager of Wuzhapnen from taking direct action for activating or deactivating personal weather station. In embodiments, and without implying any limitation, system includes device capable of receiving instructions from (or being operated by) event manager, for example, for activating and deactivating. The device can include password that is assigned to event manager, that restricts the ability of activating or deactivating to manager of system and to event manager. In embodiments, a common password can be used simultaneously for all event managers, e.g., of an automobile exhibition, an ethnic crafts fair, a competition surfing event, a cross-country skiing event, and the like.

Alternative names of web site include, e.g., Wuzzhappnin, Wuzhappenin', Whutsup; Wotsgoin'On; Wuzz-shakin', and the like.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Merriam-Webster's Unabridged Dictionary, the latest edition of which is hereby incorporated by reference.

Finally, all references listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant.

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

What is claimed is:

1. A system comprising:
an environmental conditions station having a plurality of environmental sensors;
at least one audio or visual device;
a computer that is in data communication with the environmental conditions station and the internet;
wherein the computer receives real-time data from the plurality of environmental sensors, and receives real-time data from one or more audio or visual devices, and
transmits the data via the internet to a remote computer requesting the data;
wherein the data comprises weather data that is specific to a location, and wherein the data also comprises non-weather data that is specific to the same location.

2. The system of claim 1, wherein the environmental conditions station comprises a portable or personal weather station, wherein the portable or personal weather station provides weather information exclusively to said system.

3. The system of claim 1, wherein the environmental conditions station consists of one or more portable or personal weather stations, wherein the at least one or more portable or personal weather stations provides weather information exclusively to said system.

4. The system of claim 1, that further provides calendaring information, wherein said calendaring information comprises information that is specific to the location.

5. The system of claim 1, wherein the location is that of a social event or a recreational event.

6. The system of claim 1, wherein the transmittal of data via the internet to a remote computer that requests the data, requires transmittal of a password from a user from the remote computer to the system.

7. The system of claim 1, comprising a plurality of environmental conditions stations,
each station in combination with at least one audio or visual device,
at least one computer that is in data communication with the plurality of environmental conditions stations and audio or visual device, the at least one computer also in data communication with the internet,
wherein each of the plurality of environmental conditions stations is in a distinct location and provides weather data that is specific to the distinct location,
and wherein each of the at least one audio or visual devices provides data that is specific to the distinct location.

8. The system of claim 1, wherein the location is that of a social event or recreational event, wherein the event is scheduled.

9. The system of claim 1, wherein the location is that of a social event or recreational event, wherein the event is ongoing, wherein the event does not have a distinct start date, or wherein the event is not scheduled.

10. The system of claim 1, that excludes weather data that is not specific to said location.

11. The system of claim 1, wherein the data from the at least one audio device comprises ambient sounds.

12. The system of claim 1, wherein said non-weather data comprises information on a plurality of areas within said location, wherein none of the areas are identical to each other in terms of size, locale, or viewing angle from said visual device.

13. The system of claim 1, wherein said non-weather data comprises information on a plurality of areas within said location, wherein each of the areas is distinct from each other.

14. The system of claim 1, wherein said non-weather data comprises one or more of information on density of mammals over a first area, density of vehicles over a second area, or density of buildings over a third area.

15. The system of claim 1, wherein the plurality of environmental sensors are capable of detecting one or more of outside temperature, wind speed, wind direction, humidity, atmospheric pressure, precipitation, intensity or wavelength of light, environmental conditions inside a building, or any combination of the above.

16. The system of claim 1 that excludes information that is weather forecast information.

17. The system of claim 1 that excludes information obtained from a weather widget.

18. The system of claim 1, further comprising a web site, wherein said real-time data is available exclusively from said web site.

19. The system of claim 1, further comprising a web site,
wherein said real-time data is available exclusively from said web site,
the system further providing calendaring information that comprises information specific to the location,
wherein said calendaring information is available from said web site.

20. A method for providing real-time data acquired from a plurality of environmental sensors and from at least one audio or visual device, comprising installing a portable or personal weather station at a first location, wherein said portable or personal weather station is wireless, and installing at least one audio or visual device at the same first location, wherein said at least one audio or visual device is wireless and does not communicate with a wire or cable, wherein said method provides real-time data using the system of claim 1.
